(19) United States
(12) Patent Application Publication
(10) Pub. No.: US 2026/0258526 A1
(43) Pub. Date: Sep. 3, 2026

(54) PROCESS FOR THE EXTRACTION OF MANGANESE

(71) Applicant: Element 25 Limited, WEST PERTH, Western Australia (AU)

(72) Inventors: Neil Jonathan Graham, Churchlands, Western Australia (AU); Leon Wesley Lima, Maylands, Western Australia (AU); Sunil Jayasekera, Ardross, Western Australia (AU)

(73) Assignee: Element 25 Limited, WEST PERTH, Western Australia (AU)

(21) Appl. No.: 19/131,686

(22) PCT Filed: Nov. 23, 2023
(86) PCT No.: PCT/AU2023/051203

§ 371 Date: May 21, 2025

(30) Foreign Application Priority Data
Nov. 25, 2022 (AU) 2022903576

(51) Int. Cl. C22B 47/00; C22B 3/08; C22B 3/32

(52) U.S. Cl. CPC C22B 47/00; C22B 3/326; C22B 3/08

(57) ABSTRACT

The present invention relates to a method for the recovery of manganese from an acidic leach solution comprising manganese ions, the method comprising the steps of: (i.) subjecting the acidic leach solution to one or more preliminary impurity removal steps to remove a substantial proportion of target impurities, thereby producing a purified leach solution containing manganese; (ii.) subjecting the purified leach solution to a solvent extraction step, comprising contacting the purified leach solution with an organic solution of a carboxylic acid to extract manganese ions into the organic solution and separating a loaded organic solution from an aqueous raffinate; and (iii.) subjecting the loaded organic solution to a stripping step, comprising contacting the loaded organic solution with an acidic strip solution to produce a manganese strip liquor.

### TECHNICAL FIELD

The present invention relates to a process for the extraction of manganese from acidic leach solutions. More particularly, the process of the present invention utilises solvent extraction to selectively recover manganese from the acidic leach solution.

### BACKGROUND ART

The following discussion of the background art is intended to facilitate an understanding of the present invention only. The discussion is not an acknowledgement or admission that any of the material referred to is or was part of the common general knowledge as at the priority date of the application.

High purity manganese products such as electrolytic manganese dioxide (EMD), electrolytic manganese metal (EMM), chemical manganese dioxide (CMD), manganese carbonate and manganese sulphate (MSM/HPMSM) are required for use in specialty metals and lithium ion battery cathodes. Demand for high purity manganese metal and high purity manganese sulphate is expected to increase dramatically in the foreseeable future, driven by growth in traditional end use markets but also a rapid expansion in electric vehicle production and grid storage devices capacity.

Manganese may be recovered from multiple sources, including naturally occurring ores, ocean nodules and industrial wastes. Hydrometallurgical processing of such materials typically involves the leaching of manganese using an acidic solution. The leaching of manganese will also leach a number of impurities, including K, Na, Ca, Mg, Se, Si, Ni, Co, Fe and Al. It is difficult to separate manganese from these impurities. Instead, it is common for the acidic leach solution to be first treated to remove such impurities before high purity manganese products can be recovered from solution.

The separation of manganese from other impurities using solvent extraction techniques is technically challenging. Common extractants used to extract impurities from acidic leach solutions, such as Cyanex 272 and DEHPA, exhibit poor selectively of the impurities over manganese, resulting in co-extraction of manganese and product loss.

Throughout this specification, unless the context requires otherwise, the word “comprise”, or variations such as “comprises” or “comprising”, will be understood to imply the inclusion of a stated integer or group of integers but not the exclusion of any other integer or group of integers.

### SUMMARY OF INVENTION

In accordance with a first aspect of the present invention, there is provided a method for the recovery of manganese from an acidic leach solution comprising manganese ions, the method comprising the steps of:
i. subjecting the acidic leach solution to one or more preliminary impurity removal steps to remove a substantial proportion of target impurities, thereby producing a purified leach solution containing manganese;
ii. subjecting the purified leach solution to a solvent extraction step, comprising contacting the purified leach solution with an organic solution of a carboxylic acid to extract manganese ions into the organic solution and separating a loaded organic solution from an aqueous raffinate; and
iii. subjecting the loaded organic solution to a stripping step, comprising contacting the loaded organic solution with an acidic strip solution to produce a manganese strip liquor.

In one form of the present invention, the target impurities do not include at least one of potassium, magnesium, calcium, and sodium. Preferably, the one or more preliminary impurity removal steps produce a purified leach solution containing manganese and one or more of potassium, magnesium, calcium, and sodium.

The inventors of the present invention have found that manganese may be preferentially extracted from solutions containing potassium, magnesium, calcium and sodium using an organic solution of a carboxylic acid. A manganese strip liquor with reduced impurity content may then be generated. The reduced impurity content of the resulting manganese strip liquor minimises the further purification steps required to recover a high purity manganese product.

In one form of the present invention, the acidic leach solution is a sulphate solution.

In one form of the present invention, the purified leach solution is substantially free of any metals not included in the group comprising manganese, potassium, magnesium, calcium and sodium. Preferably, the concentration of any metals not included in the group comprising manganese, potassium, magnesium, calcium and sodium is less than 100 ppm. More preferably, the concentration is less than 10 ppm. Still preferably, the concentration is less than 5 ppm.

In one form of the present invention, the one or more preliminary impurity removal steps target the removal of one or more of iron, aluminium, nickel, copper, zinc, cobalt, titanium, cadmium, mercury, lead, selenium, silica, arsenic and chromium from the acidic leach solution. Preferably, the one or more preliminary impurity removal steps reduce the concentration any iron, aluminium, nickel, copper, zinc, cobalt, titanium, cadmium, mercury, lead, selenium, silica, arsenic or chromium in the acidic leach solution to a concentration of less than 100 ppm. More preferably, the concentration is less than 10 ppm. Still preferably, the concentration is less than 5 ppm.

In one form of the present invention, the solvent extraction step is conducted at pH 5-7.5. Preferably, the solvent extraction step is conducted at pH 6-7. More preferably the solvent extraction step is conducted at pH 6-6.5.

In one form of the present invention, the solvent extraction step is conducted at a temperature of 30 to 50° C.

In a preferred form of the present invention, the solvent extraction step is repeated two or more times. Preferably, the solvent extraction step is repeated in a counter-current operation.

In one form of the present invention, the loaded organic solution is subjected to a scrubbing step comprising contacting the loaded organic with a scrub solution to displace impurities in the loaded organic solution. Preferably, a portion of the manganese strip liquor is used as the scrub solution.

In one form of the present invention, the loaded organic solution is subjected to a washing step comprising contacting the loaded organic with an aqueous wash solution to remove water soluble impurities in the loaded organic solution. Preferably, the aqueous wash solution is demineralised water.

In one form of the present invention, the carboxylic acid is a trialkylacetic acid. Preferably, the carboxylic acid is a C10 carboxylic acid. More preferably, the carboxylic acid is a C10 tertiary carboxylic acid.

In one form of the present invention, the carboxylic acid is a neodecanoic acid.

In one form of the present invention, the organic solution comprises no other metal extractants. Preferably, the organic solution contains only carboxylic acid.

In one form of the present invention, the strip solution comprises sulphuric acid or hydrochloric acid.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a flowsheet of the process of the present invention;

FIG. 2 is plot showing a pH isotherm; and

FIG. 3 is plot of the results from a solvent extraction trial.

### DESCRIPTION OF EMBODIMENTS

The present invention relates generally to the recovery of manganese from acidic leach solutions using a solvent extraction process.

The acidic leach solution may be any acidic solution that contains manganese ions. Preferably, the acidic solution is a sulphate solution.

In one embodiment, the manganese concentration in the acidic leach solution is at least 50 g/L. In one embodiment, the manganese concentration in the acidic leach solution is at least 60 g/L. In one embodiment, the manganese concentration in the acidic leach solution is at least 70 g/L. In one embodiment, the manganese concentration in the acidic leach solution is at least 80 g/L. In one embodiment, the manganese concentration in the acidic leach solution is at least 90 g/L.

In one embodiment, the method of present invention comprises contacting a manganese containing material with an acidic leachant to produce the acidic leach solution. Preferably, the acidic leachant is sulphuric acid. Methods for the acid leaching of materials are well known to those skilled in the art and include, for example, atmospheric leaching, pressure leaching, oxidative leaching and reductive leaching. The most appropriate leach process will often be dictated by the manganese material itself and the oxidation state of the manganese. Suitable manganese containing materials include ores, ocean nodules and industrial wastes.

The acid leaching of manganese materials will also leach impurity elements into solution together with manganese. The extractant used in the solvent extraction step of the present invention has been found to demonstrate preferential extraction of manganese over potassium, magnesium, calcium and sodium. However, other metals have been found to co-extract with manganese. The acidic leach solution is subjected to one or more impurity removal steps to remove at least a substantial portion of target impurities, prior to the solvent extraction step.

Throughout this specification, unless the context requires otherwise, the term “target impurities” will be understood to refer to metal impurities in the acidic leach solution which would co-extract with manganese in the solvent extraction step. Furthermore, potassium, magnesium, calcium and sodium are not considered to fall within the scope of “target impurities”.

Throughout this specification, unless the context requires otherwise, the term “remove a substantial portion” will be understood to refer to a reduction in the concentration of the target impurity to below a threshold concentration. The threshold concentration will depend on the allowable content of that impurity in the manganese product and the manganese concentration in the acidic leach solution. As would be appreciated by a person skilled in the art, the allowable content of impurities in high purity manganese products will depend on the application of that product. For example, high purity manganese for use in lithium-ion batteries will have to meet particular impurity specifications. The threshold concentration should be adjusted to meet the required specifications. In a preferred embodiment of the present invention, the threshold concentration of the target impurities is 100 ppm. Furthermore, it should be understood that the threshold concentration will also be dependent on the concentration of manganese in the acidic leach solution. The factor from liquor at 100 g/l Mn is around 3 and so a concentration of 3 ppm in liquor will result in about 10 ppm at 100 g/t Mn.

The impurities present in the acidic leach solution will depend on the manganese containing material being leached. Preferably, the one of more impurity removal steps will remove a substantial portion of any iron, aluminium, nickel, copper, zinc, cobalt, titanium, cadmium, mercury, lead, selenium, silica, arsenic and chromium from the acidic leach solution.

It is envisaged that any means available to those in the art may be used to remove the target impurities. It is envisaged that sequential impurity removal steps may be used to remove different target impurities. It is further envisaged that sequential impurity removal steps may be used to remove varying amounts of target impurities. For example, a first impurity removal step may be used to remove a large portion of a target impurity and a second impurity removal step may be used to remove remaining trace amounts. The choice of impurity removal means will depend on the particular impurities in the acidic leach solution.

In one embodiment of the present invention, the preliminary impurity removal steps comprise a neutralisation step. Preferably, the neutralisation step comprises the addition of a neutralisation agent to increase the solution pH to a point when one or more target impurities precipitate. The neutralisation step may further comprise the addition of a reductant or an oxidant. The neutralisation agent should preferably contain a cation selected from K⁺, Mg²⁺, Ca²⁺, NH⁴⁺, Mn²⁺ or Na⁺. The resulting slurry undergoes a solid/liquid separation to remove the precipitated solids from the solution. Preferably, the neutralisation step will not increase the pH of the acidic leach solution above 6.

In one embodiment of the present invention, the preliminary impurity removal steps comprise a pressure precipitation step. The pressure precipitation comprises subjecting the acidic leach solution to elevated temperature and pressure for a time sufficient to precipitate target impurities from the acidic leach solution. Preferably, the pressure precipitation step is carried out in a pressurised reactor. In one form of the present invention, the pressure precipitation step is conducted at a pressure of at least 2 bar. In one form of the present invention, the pressure precipitation step is conducted at a pressure between 2 and 10 bar. In one form of the present invention, the pressure precipitation step is conducted at a temperature of at least 135° C. Preferably, the pressure precipitation step is conducted at a temperature of at least 150° C. More preferably, the pressure precipitation step is conducted at a temperature of at least 160° C. In one form of the present invention, the pressure precipitation step is conducted at a temperature between 135° C. and 200° C. Preferably, the pressure precipitation step is conducted at a temperature between 160° C. and 180° C. In one form of the present invention, the residence time of the pressure precipitation step is at least 30 minutes. Preferably, the residence time of the pressure precipitation step is 30-120 minutes. Such a pressure precipitation step will produce an iron-rich precipitate. The resulting slurry undergoes a solid/liquid separation to remove the precipitated solids from the solution.

In one embodiment of the present invention, the preliminary removal steps comprise one or more solvent extraction steps. Each solvent extraction step comprises to contact of the acidic leach solution with an organic solution of an extractant suitable to selectively extract one or more target impurities from the acidic leach solution whilst substantially rejecting manganese. Preferably, the one or more solvent extraction step will remove iron and/or aluminium from the acidic leach solution.

In one embodiment of the present invention, the preliminary removal steps comprise one or more ion exchange steps. Each ion exchange step comprises the contact of the acidic leach solution with a sorbent material to selectively extract one or more target impurities from the acidic leach solution whilst rejecting manganese. The sorbents used will depend on the impurities of the acidic leach solution and those skilled in the art would be aware of suitable sorbents to remove such impurities.

In one form of the present invention, the preliminary removal steps comprise one or more precipitation steps comprising contacting the acidic leach solution with a precipitant. Any precipitant that leads to precipitation of one or more target impurities will be suitable. In one embodiment, the precipitant is sodium dimethyldithiocarbamate, sodium trithiocarbonate, sodium polythiocarbonate or mixture thereof.

In one form of the present invention, the preliminary removal steps comprise a sulphiding step comprising contacting acidic leach solution with a sulphiding agent. Possible sulphiding agents include Na₂S, BaS, (NH₄)HS, (NH₄)₂S, H₂S and NaHS. The addition of the sulphiding agent will lead to the precipitation of residual target impurity metals as a metal sulphide. The resulting slurry undergoes a solid/liquid separation to remove the precipitated solids from the solution.

In one form of the present invention, the preliminary removal steps comprise a fluoridation step comprising contacting acidic leach solution with a fluoriding agent. The addition of the fluoriding agent will lead to the precipitation of residual target impurity metals as a metal fluoride. Suitable fluoridization agents include NH₄F and BaF₂. The resulting slurry undergoes a solid/liquid separation to remove the precipitated solids from the solution.

The one or more impurity removal steps will produce a purified leach solution. In one embodiment of the present invention, the purified solution is substantially free of any target impurities. As detailed above, any metal not included in the group of manganese, potassium, magnesium, calcium and sodium should be considered as a target impurity. The actual target impurities present in the acidic leach solution will be determined by the manganese containing material that is processed to form the acidic leach solution. Preferably, the purified solution is substantially free of any iron, aluminium, nickel, copper, zinc, cobalt, titanium, cadmium, mercury, lead, selenium, silica, arsenic and chromium.

In one embodiment of the present invention, the purified leach solution comprises the following:
Fe: 0-100 ppm
Al: 0-100 ppm
Ni: 0-1000 ppm
Cu: 0-100 ppm
Zn: 0-100 ppm
Co: 0-1000 ppm

In one embodiment of the present invention, the purified leach solution comprises the following:
Fe: 0-100 ppm
Al: 0-100 ppm
Ni: 0-1000 ppm
Ti: 0-100 ppm
Cd: 0-100 ppm
Hg: 0-100 ppm
Cu: 0-100 ppm
Zn: 0-100 ppm
Pb: 0-100 ppm
Co: 0-1000 ppm
Cr: 0-100 ppm

In one embodiment of the present invention, the purified leach solution comprises the following:
Fe: 0-100 ppm
Al: 0-100 ppm
Ni: 0-100 ppm
Cu: 0-100 ppm
Zn: 0-100 ppm
Co: 0-100 ppm

In one embodiment of the present invention, the purified leach solution comprises the following:
Fe: 0-100 ppm
Al: 0-100 ppm
Ni: 0-100 ppm
Ti: 0-100 ppm
Cd: 0-100 ppm
Hg: 0-100 ppm
Cu: 0-100 ppm
Zn: 0-100 ppm
Pb: 0-100 ppm
Co: 0-100 ppm
Cr: 0-100 ppm

In one embodiment of the present invention, the purified leach solution comprises the following:
Fe: 0-5 ppm
Al: 0-5 ppm
Ni: 0-25 ppm
Ti: 0-5 ppm
Cd 0-5 ppm
Hg: 0-2 ppm
Cu: 0-5 ppm
Zn: 0-5 ppm
Pb: 0-5 ppm
Co: 0-25 ppm
Cr: 0-5 ppm

In one embodiment of the present invention, the purified leach solution comprises the following:
Fe: 0-2 ppm
Al: 0-2 ppm
Ni: 0-2 ppm
Ti: 0-2 ppm
Cd 0-1 ppm
Hg: 0-1 ppm
Cu: 0-2 ppm
Zn: 0-2 ppm
Pb: 0-1 ppm
Co 0-2 ppm
Cr: 0-1 ppm

In one embodiment of the present invention, the purified leach solution comprises the following:
Fe: 0-10 ppm
Al: 0-10 ppm
Ni: 0-25 ppm
Ti: 0-100 ppm
Cd: 0-5 ppm
Hg: 0-100 ppm
Cu: 0-5 ppm
Zn: 0-10 ppm
Pb: 0-100 ppm
Co: 0-25 ppm
Cr: 0-5 ppm

In one embodiment, the purified leach solution comprises the following:
Mn: 50-150 g/L
K: 0-100 g/L
Mg: 0-100 g/L
Ca: 0-100 g/L
Na: 0-300 g/L

In one embodiment, the purified leach solution comprises the following:
Mn: 90-150 g/L
K: 0-100 g/L
Mg: 0-50 g/L
Ca: 0-50 g/L
Na: 0-230 g/L

In a preferred embodiment of the present invention, the purified leach solution comprises the following:
Fe: 0-100 ppm
Al: 0-100 ppm
Ni: 0-1000 ppm
Cu: 0-100 ppm
Zn: 0-100 ppm
Co: 0-1000 ppm
Mn: 50-170 g/L
K: 0-100 g/L
Mg: 0-100 g/L
Ca: 0-100 g/L
Na: 0-300 g/L

In a preferred embodiment of the present invention, the purified leach solution comprises the following:
Fe: 0-100 ppm
Al: 0-100 ppm
Ni: 0-100 ppm
Cu 0-100 ppm
Zn: 0-100 ppm
Co: 0-100 ppm
Mn: 50-150 g/L
K: 0-100 g/L
Mg: 0-100 g/L
Ca: 0-100 g/L
Na: 0-300 g/L

In one embodiment of the present invention, the purified leach solution comprises the following:
Fe: 0-5 ppm
Al: 0-5 ppm
Ni: 0-25 ppm
Cu 0-5 ppm
Zn: 0-5 ppm
Co: 0-25 ppm
Mn: 50-150 g/L
K: 0-100 g/L
Mg: 0-100 g/L
Ca 0-100 g/L
Na: 0-300 g/L

The purified leach solution is then subjected to a solvent extraction step, comprising contacting the purified leach solution with an organic solution of a carboxylic acid to extract manganese ions into the organic phase.

Throughout this specification, unless the context requires otherwise, the term “organic solution of a carboxylic acid” will be understood to refer to an organic compound dissolved in an organic solvent (or diluent), where the carboxylic acid has an available proton which can be exchanged with a manganese ion from the acidic leach solution.

Throughout this specification, unless the context requires otherwise, the term “loaded organic solution” and similar variations, will be understood to refer to an organic solution containing a carboxylic acid that has been enriched with manganese ions that have transferred from the acidic leach solution to the extractant.

Throughout this specification, unless the context requires otherwise, the term “scrubbing” will be understood to refer to a purification step of a loaded extractant in which at least some undesired elements are removed.

Throughout this specification, unless the context requires otherwise, the term “washing” will be understood to refer to a purification step of a loaded extractant in which at least some undesired elements are removed using an aqueous wash solution.

Throughout this specification, unless the context requires otherwise, the term “stripping” will be understood to refer to a step transferring a metal of interest from the loaded organic solution to an aqueous phase by addition of a strip solution.

As discussed above, the solvent extraction step comprises the contact of the purified leach solution with an organic solution of a carboxylic acid.

Throughout this specification, unless the context requires otherwise, the term “carboxylic acid” will be understood to refer to an organic compound having the general formula R—COOH, with R representing any optionally substituted aliphatic or aromatic group, or combinations of these groups. Such groups include optionally substituted alkyl, alkenyl, alkynyl, aryl, or heteroaryl groups. The term “optionally substituted” should be understood to imply that the group may or may not be further substituted with one or more groups.

Preferably, the carboxylic acid is a trialkylacetic acid. In the current context, the term trialkylacetic acid refers to a carboxylic acid with three alkyl groups on the alpha-carbon. The term “alkyl” should be understood to denote straight chain, branched, mono-cyclic or poly-cyclic alkyls.

Preferably, the carboxylic acid is a C10 carboxylic acid. More preferably, the carboxylic acid is a C10 tertiary carboxylic acid. Still preferably, the carboxylic acid may be represented as:

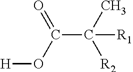

where R1 and R2 are alkyl groups and R1+R2=7 carbons

In one embodiment, the carboxylic acid is neodecanoic acid. Neodecanoic acid is sold under the trade name Versatic 10 (Hexion).

The organic solution may be any suitable organic solvent known in the art. In preferred embodiments, the organic solution is an aliphatic hydrocarbon solution. Suitable organic solutions include Vivasol D80, Shellsol D80 and Exxsol D80.

The concentration of the carboxylic acid in the organic solution is dependent on the viscosity and the concentration of manganese in the acidic leach solution. In one embodiment, the concentration of the carboxylic acid in the organic solution is between 30-60%

In one embodiment, the pH of the acidic leach solution is between 5-7.5. In one embodiment, the pH of the acidic leach solution is between 6-7. In one embodiment, the pH of the acidic leach solution is between 6-6.5. The pH of the acidic leach solution is maintained within the range of 5-7.5 for the duration of the solvent extraction step. Suitable neutralisation agent may be added to each mixer settler to maintain the pH within this range.

The solvent extraction step is conducted at a temperature of 30 to 50° C.

The organic to aqueous ratio (O:A) in the solvent extraction step is within the range 1:10-10:1. Preferably, the O:A in the solvent extraction step is 3.5-4:1. As would be appreciated by a person skilled in the art, the ratio of organic to aqueous in the extraction stage is dependent on the manganese tenor in the pregnant leach solution as well as the loading of manganese on the organic. One method for calculation of equilibrium concentration of extractant is using the material balance, i.e. it is equal to the difference between total (analytical) concentration of extractant and the sum of all solvated species in the solvent phase.

The solvent extraction step loads manganese ions into the organic solution. The loaded organic phase is then separated from the Mn-depleted aqueous phase. The contact of the acidic leach solution and the organic solution of a carboxylic acid and the subsequent separation of the loaded organic phase is conducted using suitable solvent extraction mixer settlers.

In one embodiment of the present invention, two or more mixer settlers are used in series. Preferably, three or more mixer settlers are used in series. In embodiments where multiple mixer settlers are used, the mixer settlers are arranged for counter-current operation. As would be appreciated by a person skilled in the art, counter-current operation is achieved by repeating single-stage contacts, with the aqueous and organic phases moving in opposite directions between the stages. The inventors have found that the use of multiple mixer settlers in counter-current operation allow for the extraction of manganese into the organic phase to be maximised, while minimising the co-extraction of other species.

In one embodiment, the loaded organic phase is subjected to a scrubbing step. The scrubbing step comprises contacting the loaded organic with a scrub solution that contains manganese ions. The scrubbing step is used to remove impurities that have been loaded onto the carboxylic acid. During the contact, manganese ions in the scrub solution preferentially load onto the carboxylic acid, displacing impurity ions.

In one form of the present invention, the scrub solution is a sulphate solution. In a preferred form of the present invention, a portion of the manganese strip liquor is used as the scrub solution.

In one embodiment, the ratio of the loaded organic to the scrub solution is between 20:1 and 100:1 (organic:aqueous) on a volume basis. Preferably the ratio is between 25:1 and 50:1 (organic:aqueous) on a volume basis. More preferably, the ratio is about 35:1 (organic:aqueous) on a volume basis.

The scrubbing step is conducted using suitable mixer settler apparatus. In one embodiment, the scrubbing step is conducted in a single mixer settler. In an alternative embodiment, the scrubbing step is conducted in two or more mixer settlers arranged in series.

In one form of the present invention, the loaded organic solution is subjected to a washing step comprising contacting the loaded organic with an aqueous wash solution to remove water soluble impurities in the loaded organic solution. Preferably, the aqueous wash solution is demineralised water. The washing step is used to remove calcium and other water soluble impurities that have loaded onto the carboxylic acid. During the contact, calcium ions in the loaded organic will transfer to the aqueous phase due to increased solubility in the aqueous phase. The aqueous phase can then be separated.

In one embodiment, the ratio of the loaded organic to the aqueous solution is between 20:1 and 100:1 (organic:aqueous) on a volume basis.

The washing step is conducted using suitable mixer settler apparatus. In one embodiment, the washing step is conducted in a single mixer settler. In an alternative embodiment, the washing step is conducted in two or more mixer settlers arranged in series.

The loaded organic resulting from the washing step is directed to the stripping step. The aqueous phase resulting from the scrubbing phase is preferably directed back to the solvent extraction step to prevent loss of manganese.

The stripping step comprises the contact of the loaded organic with an acidic strip solution to displace the majority of the manganese ions from the loaded organic into the aqueous phase, producing a manganese strip liquor. The resulting organic phase is recycled back to the solvent extraction step.

In a preferred embodiment, the acidic strip solution comprises sulphuric acid. In one embodiment, the sulphuric acid concentration is at least 100 g/L.

The contact of the loaded organic and the acidic strip solution is conducted using suitable solvent extraction mixer settler apparatus. In one embodiment of the present invention, two or more mixer settlers are used in series. Preferably, three or more mixer settlers are used in series. In embodiments where multiple mixer settlers are used, the mixer settlers are arranged for counter-current operation.

The produced manganese strip liquor has high manganese purity. In embodiments where the sulphuric acid is used as the strip solution, the manganese strip liquor is a high purity manganese sulphate solution.

A manganese product may be recovered from the manganese strip liquor.

In one embodiment, the manganese strip liquor is directed to a crystallization step to recover manganese sulphate. In the crystallisation step, evaporation is used to remove water from the manganese strip liquor to crystallise manganese sulphate. The resulting slurry is subjected to solid liquid separation step to recover manganese sulphate. Preferably, the crystallisation step is a partitioning step. As would be appreciated by a person skilled in the art, partitioning does not fully remove all water from the manganese strip liquor. This prevents any residual impurities from crystallising together with manganese sulphate. Preferably about 90% of the water is removed.

It is envisaged that other manganese recovery means may be incorporated into the process. In an alternative embodiment, an electrowinning circuit may be used to recover EMM and/or EMD. Those skilled in the art would recognise that other means of manganese recovery may also be implemented.

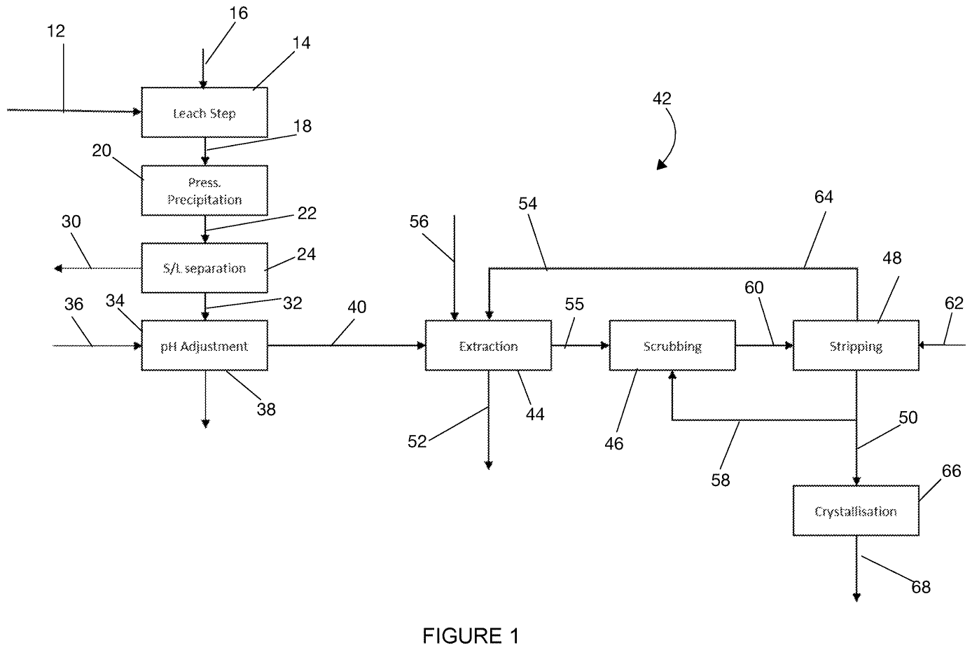

FIG. 1 depicts a flowsheet of a method for the recovery of manganese from an acidic leach solution in accordance with one embodiment of the present invention.

In the embodiment shown in FIG. 1, a manganese containing material 12 is subjected to a leach step 14, where it is contacted with an acidic leachant 16 to extract manganese into solution.

The resulting leach slurry 18 is directed to one or more impurity removal steps to remove target impurities from solution. It is envisaged that the leach slurry 18 may be directed to a solid liquid separation step (not shown) to remove the leach residue before further processing. This will be determined by the particular impurity removal steps used.

In the embodiment shown in FIG. 1, leach slurry 18 is first directed to a pressure precipitation step 20 comprising subjecting the leach slurry 18 to elevated temperature and pressure for a time sufficient to precipitate dissolved impurities from the leach slurry 18. The resulting slurry 22 is directed to a solid liquid separation step 24 to remove the precipitated species 30.

The resulting solution 32 is directed to a neutralisation step 34 where it is contacted with a neutralisation reagent 36, such as limestone, to increase the solution pH to between 3 and 6.5. The increase in solution pH will lead to the precipitation of impurities in the solution without precipitating manganese. The predominant species precipitated is calcium sulfate. The resulting slurry undergoes a solid/liquid separation to remove the precipitated solids 38 from the recovered solution 40.

The resulting solution may be subjected to one or more further impurity removal steps (not shown). It is envisaged that one of the impurity removal steps may be a sulphating step, comprising the addition of a sulphiding agent to precipitate target impurities as solid sulphates. Suitable sulphiding agents may be selected from NaHS, Na₂S, H₂S and BaS. Alternatively or additionally, one of the impurity removal steps may a ion exchange step to remove the minor amounts of remaining target impurities, such as copper, cobalt and nickel from solution.

The one or more impurity removal steps will produce a purified leach solution 40 which is substantially free of any target impurities.

The purified leach solution 40 is passed to a manganese solvent extraction circuit 42 to recover manganese. In the embodiment shown in the FIG. 1, the manganese solvent extraction circuit 42 comprises an extraction stage 44, a scrubbing stage 46 and a stripping stage 48 to selectively recover manganese from the purified leach solution 40 into a manganese strip liquor 50. The Mn-free raffinate 52 is directed to a holding tank for further processing.

In the extraction phase, the purified leach solution 40 is contacted with an organic solution of a carboxylic acid 54 to selectively extract manganese from the purified leach solution 40 into a loaded organic phase 55. The extraction stage 44 preferably comprises multiple solvent extraction mixer settlers arranged in series. The purified leach solution 40 and the organic solution of a carboxylic acid 54 are contacted in a counter-current arrangement to maximize extraction efficiency. A neutralisation agent 56 is dosed to each of the mixer-settlers to maintain a target pH

The loaded organic phase 54 is directed to a scrubbing stage 46. In scrubbing stage 46, the manganese loaded extractant 54 is contacted with a portion of a scrub solution 58 that contains manganese ions. The manganese ions in the scrub solution 58 preferentially loads onto the loaded extractant 54 and displaces any impurity elements loaded onto the loaded extractant 54 in the extraction stage 44.

The aqueous phase from the scrubbing stage 46 is directed back to the first extraction mixer-settler. Loaded extractant 60 from the scrubbing stage 46 advances to a stripping stage 48.

In the stripping stage 48, the loaded extractant 60 is contacted with an acidic strip solution 62 to displace the majority of manganese ions on the organic into the aqueous phase, producing the manganese strip liquor 50.

The organic phase 64 exiting the stripping stage 48 is recycled to the extraction stage 44 where it again loads with manganese. In this way the organic phase 64 is kept in a closed circuit within the manganese solvent extraction circuit 42.

The manganese strip liquor 50 from the stripping stage 48 is directed to a manganese crystallization stage 66. The manganese crystallization stage 66 produces a slurry of manganese sulfate penthydrate and in a sulphuric liquor. The slurry is passed to a suitable solid liquid separation step to separate the manganese sulfate solids 68.

### Example 1

A trial was conducted to examine the effect that pH had of the extraction of various species from aqueous solutions using organic extractants containing carboxylic acid. The organic used in the trial was a 60% v/v Versatic 10 in Vivasol D80. The trial was conducted at 30° C. with a phase ratio (O/A) of 1.0.

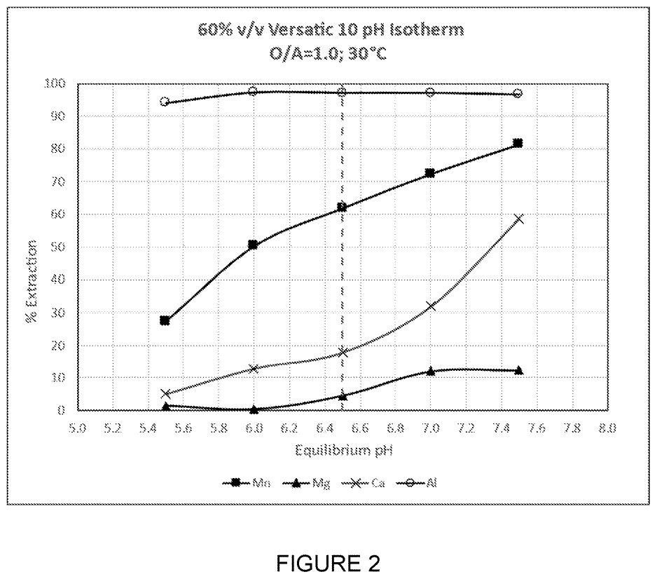

The results of the trial were used to construct a pH isotherm. This isotherm is shown in FIG. 2. These results show that the amount of manganese increases as the pH is increased from pH 5.5 to 7.5 These results also show that the co-extraction of calcium and magnesium also increases across this range. The results indicate that the preferred pH for the extraction of manganese, while minimising co-extraction of calcium and magnesium occurs at pH 6 to 7. The maximum ratio of manganese to calcium/magnesium occurs at approximately pH 6.5.

### Example 2

A trial was conducted to determine whether manganese could be effectively recovered from an acidic leach solution containing calcium and magnesium. The solvent extraction was conducted using the following conditions:
Aqueous: 90 g/L Mn with Ca & Mg (synthetic) B137784,
Organic: (60% v/v Versatic 10 in Vivasol D80, acid washed)
Tested at an equilibrium pH of 6 and a phase ratio (O/A) of 1.

The results are shown in Table 1.

TABLE 1
Extraction Results

| Successive Contact Number | | | Feed | 1 | 2 | 3 |
|---|---|---|---|---|---|---|
| Sample | | ORG | | EO1 | EO2 | EO3 |
| Coding | | AQ | EF | ER1 | ER2 | ER3 |
| Equilibrium | | | 3.83 | 5.25 | 6.01 | 6.12 |
| pH at Temp | | | | | | |
| Equilibrium Temp | | ° C. | 25 | 34 | 33 | 34 |
| Organic In | | mL | 400 | 400 | 370 | 350 |
| Organic Out | | mL | | 395 | 356 | 345 |
| Density | | g/mL | 0.86 | 0.8787 | 0.9148 | 0 |
| Aqueous In | | mL | 400 | 400 | 400 | 400 |
| Aqueous Density, | | g/mL | 1.2204 | 1.2043 | 1.1862 | 1.2128 |
| g/mL | | | | | | |
| Aqueous Out | | mL | | 435 | 460 | 420 |
| 200 g/L NaOH | | g | | 29.94 | 70.71 | 14.45 |
| density, g/mL | 1.2135 | | | | | |
| Modifier Volume | | mL | | 24.67 | 68.27 | 11.91 |
| | | sec | | | B.4 | 58 |
| Mn | Org Assay | mg/L | 0 | 9956 | 30910 | 38493 |
| | Aq Assay | mg/L | 78010 | 66600 | 50420 | 73020 |
| | % Successive Loading | | | 12.8 | 22.2 | 6.3 |
| | Distribution | | | 0.2 | 0.8 | 0.5 |
| | Coeff. (O/A) | | | | | |
| | (OUT/IN) % | | | 104 | 99 | 105 |
| Mg | Org Assay | mg/L | 0 | 9.6 | 10.2 | 10.0 |
| | Aq Assay | mg/L | 1414 | 1334 | 1192 | 1384 |
| | % Successive Loading | | | 0.68 | 0.04 | −0.01 |
| | Distribution | | | 0.0 | 0.0 | 0.0 |
| | Coeff. (O/A) | | | | | |
| | (OUT/IN) % | | | 103 | 97 | 103 |
| Ca | Org Assay | mg/L | 0 | 48 | 51 | 50 |
| | Aq Assay | mg/L | 480 | 440 | 405 | 480 |
| | % Successive Loading | | | 2.0 | −6.6 | −6.8 |
| | Distribution | | | 0.0 | 0.0 | 0.0 |
| | Coeff. (O/A) | | | | | |
| | (OUT/IN) % | | | 102 | 91 | 88 |

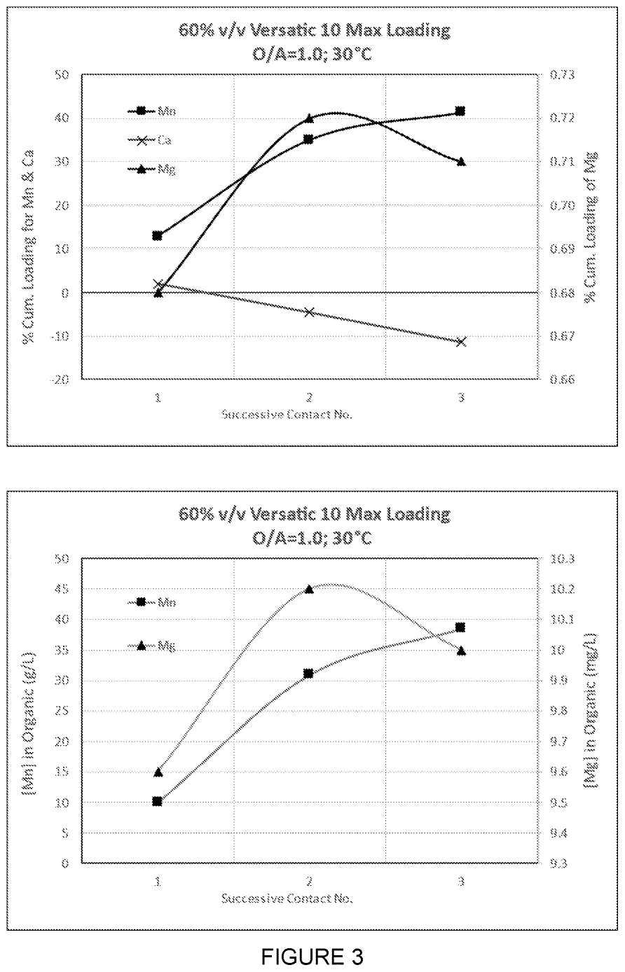

The loading of each species across successive contacts is shown in FIG. 3.

The results show that manganese was loaded on Versatic 10. It also showed that under optimised conditions, the concentration of co-extracted calcium and magnesium can be decreased by preferentially loading Mn on Versatic 10 across multiple contacts.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

1. A method for the recovery of manganese from an acidic leach solution comprising manganese ions, the method comprising the steps of:
i. subjecting the acidic leach solution to one or more preliminary impurity removal steps to remove a substantial proportion of target impurities, thereby producing a purified leach solution containing manganese;
ii. subjecting the purified leach solution to a solvent extraction step, comprising contacting the purified leach solution with an organic solution of a carboxylic acid to extract manganese ions into the organic solution and separating a loaded organic solution from an aqueous raffinate; and
iii. subjecting the loaded organic solution to a stripping step, comprising contacting the loaded organic solution with an acidic strip solution to produce a manganese strip liquor.

2. The method according to claim 1, wherein the target impurities do not include at least one of potassium, magnesium, calcium, and sodium.

3. The method according to claim 1, wherein the one or more preliminary impurity removal steps produce a purified leach solution containing manganese and one or more of potassium, magnesium, calcium, and sodium.

4. The method according to claim 1, wherein the acidic leach solution is a sulphate solution.

5. The method according to claim 1, wherein the purified leach solution is substantially free of any metals not included in the group comprising manganese, potassium, magnesium, calcium, and sodium.

6. The method according to claim 5, wherein the concentration of any metals not included in the group comprising manganese, potassium, magnesium, calcium, and sodium is less than 100 ppm.

7. The method according to claim 1, wherein the solvent extraction step is conducted at pH 5-7.5.

8. The method according to claim 1, wherein the solvent extraction step is repeated two or more times.

9. The method according to claim 8, wherein the solvent extraction step is repeated in a counter-current operation.

10. The method according to claim 1, wherein the carboxylic acid is a trialkylacetic acid.

11. The method according to claim 1, wherein the carboxylic acid is a C10 carboxylic acid.

12. The method according to claim 11, wherein the carboxylic acid is a C10 tertiary carboxylic acid.

13. The method according to claim 11, wherein the carboxylic acid is a neodecanoic acid.

14. The method according to claim 1, wherein the organic solution comprises no other metal extractants.

15. The method according to claim 1, wherein the strip solution comprises sulphuric acid or hydrochloric acid.
